(19) United States
(12) Patent Application Publication
(10) Pub. No.: US 2012/0163216 A1
(43) Pub. Date: Jun. 28, 2012

(54) MEDIA ACCESS CONTROL APPARATUS AND METHOD IN WIRELESS LOCAL AREA NETWORK SYSTEM

(75) Inventors: Hyun-Gu PARK, Daejeon (KR); Sok-Kyu LEE, Daejeon (KR)

(73) Assignee: Electronics and Telecommunications Research Institute, Daejeon (KR)

(21) Appl. No.: 13/333,907

(22) Filed: Dec. 21, 2011

(30) Foreign Application Priority Data
Dec. 22, 2010 (KR) 10-2010-0132760

(51) Int. Cl. H04W 24/00; H04L 12/26

(52) U.S. Cl. 370/252

(57) ABSTRACT

Disclosed is a media access control apparatus and method in a wireless local area network (LAN) system, which improves the performance of a wireless network by obtaining a transmission opportunity based on information on a station (STA), received from an access point (AP) in a contention-based distributed media access control system such as an IEEE 802.11 wireless LAN system. In the media access control apparatus and method, a station determines a contention window (CW) value based on information on other stations accessing a same access point and information on the idle state of a channel, so that an inefficient CW value is be set in a Distributed Coordination Function (DCF) used in the IEEE 802.11. Accordingly, it is possible to increase the processing speed of the station and to the efficiency of a wireless LAN network.

### CROSS-REFERENCE TO RELATED APPLICATIONS

The present application claims priority of Korean Patent Application No. 10-2010-0132760, field on Dec. 22, 2010, which is incorporated herein by reference in its entirety.

### BACKGROUND OF THE INVENTION

1. Field of the Invention

Exemplary embodiments of the present invention relate to a media access control apparatus and method in a wireless local area network (LAN) system, which improves the performance of a wireless network by obtaining a transmission opportunity based on information on a station (STA), received from an access point (AP) in a contention-based distributed media access control system such as an IEEE 802.11 wireless LAN system.

2. Description of Related Art

In the IEEE 802.11, a Distributed Coordination Function (DCF) is used as a method for accessing a wireless channel. In the DCF, all stations use channels through contentions in an equal relationship based on a Carrier Sense Multiple Access with Collision Avoidance (CSMA/CA).

In the basic operation of the DCF, a station having a frame to be transmitted initiates a Content Window (CW) value to a minimum Content Window (CWmin) in a backoff stage 0 after a Distributed Inter Frame Space (DIFS) passes, and randomly selects a backoff counter in the range from 0 to the CWmin.

However, the CW is always reset to the CWmin when one station succeeds in data transmission in the DFC, the probability of collision is increased just after the success in data transmission, and therefore, the efficiency of the system is deteriorated.

As described above, in the DCF, the performance of the system is deteriorated in terms of throughput and delay when the number of contention stations is small or large.

### SUMMARY OF THE INVENTION

An embodiment of the present invention is directed to a media access control apparatus and method in a wireless LAN system, which increase the processing speed of a station and thus improve the efficiency of a wireless LAN network by solving problems caused by a method of adjusting a CW in a DCF, which is used as a media access control method in the IEEE 802.11.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a media access control apparatus in a wireless LAN system includes a station count extraction unit configured to extract a station count contained in a BSS load element in information existing in a beacon received by a station from an access point through a wireless reception unit; an access station number estimation unit configured to estimate a number of stations accessing the access point when the BSS load element does not exist in the beacon received by the station from the access point through the wireless reception unit; a minimum contention window (CWmin) determination unit configured to determine a CWmin based on the number of stations accessing the access point, which the station count extraction unit extracts or the access station number estimation unit estimates; and a contention window (CW) setting unit configured to set a CW based on the CWmin determined by the CWmin determination unit and provide the set CW to a wireless transmission unit so as to transmit data to the access point.

The access station number estimation unit may estimate the number of stations accessing the access point and calculate the CWmin based on the estimated number of stations, when the BSS load element does not exist in the beacon.

In accordance with another embodiment of the present invention, a media access control method in a wireless LAN system includes extracting a station count from a BSS load element existing in a beacon, when a station receives the beacon from an access point through a wireless reception unit; determining a CWmin based on the extracted station count; setting a CW by randomly selecting a value in a range from 0 to the determined CWmin; and transmitting a packet to the access point through a wireless transmission unit, when the CW becomes 0 by decreasing the CW by one when a channel is in an idle state during one slot time.

After the transmitting of the packet to the access point, although the station does not receive an acknowledgement (ACK) due to a channel error or collision between packets, the CWmin may be maintained as it is.

When the BSS load element does not exist in the beacon, a number of stations accessing the access point may be estimated, and the CWmin may be calculated based on the estimated number of stations.

The estimating of the number of stations may identify a source address field and a BSSID field in an MAC header field of a currently transmitted packet when the channel is not in the idle state, add an address to a database (DB) when the BSSID field is identical to the address of the access point to which the BSSID field belongs and the address existing in the source address field does not exist in the DB, and estimate a number obtained by increasing a current number of stations by one as the number of stations accessing the access point.

The estimating of the number of stations may identify a source address field and a BSSID field in an MAC header field of a currently transmitted packet when the channel is not in the idle state, renew a timestamp value of an address when the BSSID field is identical to the address of the access point to which the BSSID field belongs and the corresponding address existing in the source address field does not exist in a DB, delete the address from the DB when the difference between a current time and the timestamp value is a predetermined value or more by periodically identifying the timestamp value existing in the DB, and estimate a number obtained by increasing a current number of stations by one as the number of stations accessing the access point.

In the determining of the CWmin based on the extracted station count, the CWmin may be determined by multiplying the station count by a proportional constant of a corresponding system.

As described above, in the media access control apparatus and method in the wireless LAN system in accordance with the present invention, a station determines a CW value based on information on other stations accessing a same access point and information on the idle state of a channel. Thus, an inefficient CW value cannot be set in the DCF used in the IEEE 802.11, so that it is possible to improve the performance and efficiency of the entire wireless LAN system.

### BRIEF DESCRIPTION OF THE DRAWINGS

FIG. 1 illustrates a situation in which a packet is damaged due to a channel error when one station exists in a wireless LAN system in accordance with an embodiment of the present invention.

FIG. 2 illustrates a situation in which a minimum CW is reset to 32 after a transmission success when many stations exist in a wireless LAN system in accordance with an embodiment of the present invention.

FIG. 3 is a block configuration diagram of a media access control apparatus in a wireless LAN system in accordance with an embodiment of the present invention.

FIG. 4 is a control flowchart illustrating a media access control method in the wireless LAN system in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In the IEEE 802.11 in accordance with embodiments of the present invention, a Distributed Coordination Function (DCF) is used as a method for accessing a wireless channel. In the DCF, all stations use channels through contentions in an equal relationship based on a Carrier Sense Multiple Access with Collision Avoidance (CSMA/CA).

In the basic operation of the DCF, a station having a frame to be transmitted initiates a Content Window (CW) value to a minimum Content Window (CWmin) in a backoff stage 0 after a Distributed Inter Frame Space (DIFS) passes, and randomly selects a backoff counter in the range from 0 to the CWmin.

After the station selects the backoff counter, the station obtains a transmission opportunity to transmit data when a channel is sensed idle during a slot time corresponding to the selected backoff counter. To this end, when the channel is sensed idle during one slot time, the station decreases the backoff counter by one. Then, the station starts transmitting the frame when the backoff counter becomes 0 from the beginning of a slot.

If a collision between packets occurs when two stations simultaneously transmit the packets in the DCF, both the stations fail in data transmission. While the presence of occurrence of a collision between packets can be immediately sensed in the Ethernet, the presence of the occurrence of the collision cannot be immediately sensed in the wireless LAN. Hence, when the station does not receive an acknowledgement (ACK) that is a response packet with respect to a transmission packet during a predetermined time, the station decides that a collision between packets occurs. When transmitting a next packet, the station sets the CW value to a greater value so as to avoid the collision.

When it is decided that a collision between packets has occurred in the DCF, a station subjected to the occurrence of the collision increases a backoff stage by one, and increases a CW value by multiplying the CW value by two until when the CW value approaches a maximum Contention Window (CWmax). The station also resets a backoff counter. A station succeeding in frame transmission resets a CW to a CWmin.

When the CW is determined in the manner described above, the CW may be set to a value at which the efficiency of the wireless network may be deteriorated.

As an example, in the wireless LAN, it is decided as a collision that a station does not receives a response packet (ACK) from an access point during a predetermined time. The station does not also receive a response packet even when an error occurs in a packet itself due to noise of a wireless channel. When the error of the packet occurs due to the noise of the wireless channel as described above, the station decides that a collision between packets has occurs, and increases a CW value by multiplying the CW value by two. Since the average of values randomly selected from the CW increased two times that of the initial CW is also two times greater than that of values randomly selected from the initial CW, the station transmits data after waiting for an idle time of the channel, which is unnecessarily increased two times that of the initial idle time.

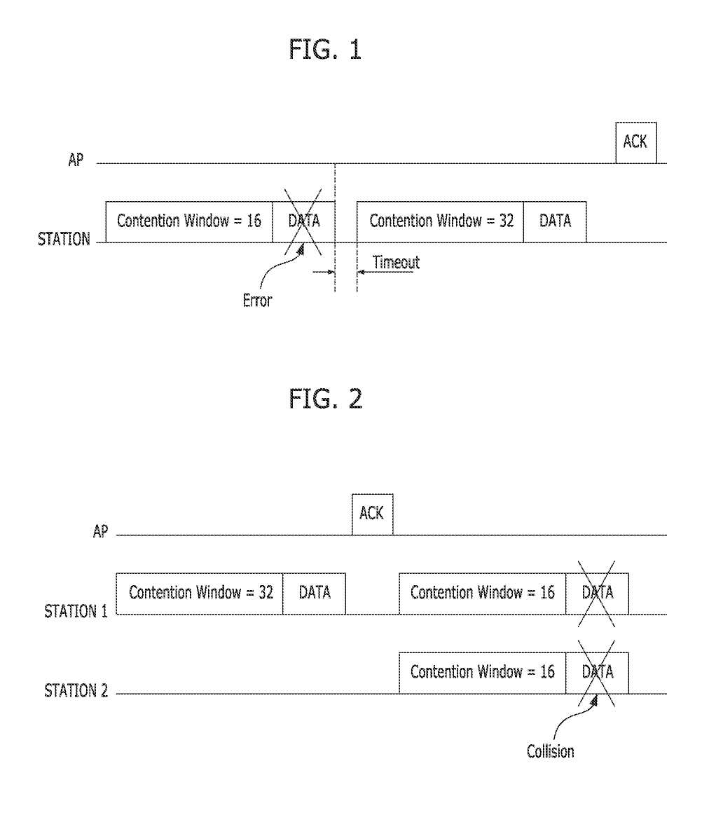

FIG. 1 illustrates a situation in which a packet is damaged due to a channel error when one station exists in a wireless LAN system in accordance with an embodiment of the present invention. The situation of FIG. 1 will be described as an example. When only one station exists as illustrated in FIG. 1, the CWmin becomes 32 slot times, and the CW randomly selected in the range from 0 to 32 becomes 16 slot times on the average. However, in FIG. 1, only one station and one access point (AP), i.e., only two systems use a channel. Therefore, when the two systems try to transmit data, each of the systems transmits the data after always waiting for 16 slot times on the average, which is very inefficient in terms of the entire wireless LAN.

More specifically, it is assumed that an error has occurred in a packet transmitted by the station. Since the station tries to transmit data after waiting for about 32 slot times increased two times that of the CW, the total used time for transmitting one data frame is ‘16 slot times+data transmission time+timeout time+32 slot times+data transmission time.’ As can be seen from the situation described above, the conventional DCF is very inefficient because one station maintains a waiting time during an average slot time even when only one contention station exists. If the one station fails in packet transmission, the situation may become more inefficient.

While the aforementioned situation is inefficient because the CWmin is greater than is required, the situation, which will be described below with reference to FIG. 2, is problematic because the CWmin is smaller than is required in a wireless LAN system in accordance with an embodiment of the present invention. When many stations belong to a Base Service Set (BBS) generated from an access point (AP), a collision between packets frequently occurs. Hence, it is advantageous to always maintain the CW as a great value.

FIG. 2 illustrates a situation in which the CWmin is reset to 32 after a transmission success when many stations exist. As illustrated in FIG. 2, a station 1 that initially tries to transmit data succeeds in data transmission, and a CW is then reset to 32 as a CWmin. When the station 1 and a station 2 try to transmit data, the CW of each of the stations 1 and 2 is selected as 16 slot times. The stations 1 and 2 try to transmit data at the same time, and therefore, a collision between packets occurs.

In the situation of FIG. 2 as an example, it is assumed that the CWs selected in the range from 0 to the CWmin (32) become 16. When the number of stations is only two, it is true that if a number is randomly selected in the range from 0 to the CWmin (32), the probability that a same number will be consecutively selected is low. However, as the number of stations is increased, the probability that a same number randomly selected in the range from 0 to the CWmin (32) is also increased.

In the IEEE 802.11 standard document, it is reported that an access point (AS) sends a beacon management packet (hereinafter, referred to as a “beacon”) every 100 ms. The beacon is used to inform stations of the existence of an IEEE 802.11 wireless network, to support a communication process between the stations and an access point (AP) and to authenticate the stations.

Stations obtain information on an access point (AP) by receiving a beacon transmitted by the access point (AP). In the information contained in the beacon received by the station from the access point (AP), a BSS load element contains a station count field. In the station count field, the number of stations currently belonging to the access point (AP) is recorded by the access point (AP). Thus, the station receiving the beacon obtains the number of stations currently belonging to the access point (AP) through the station count field.

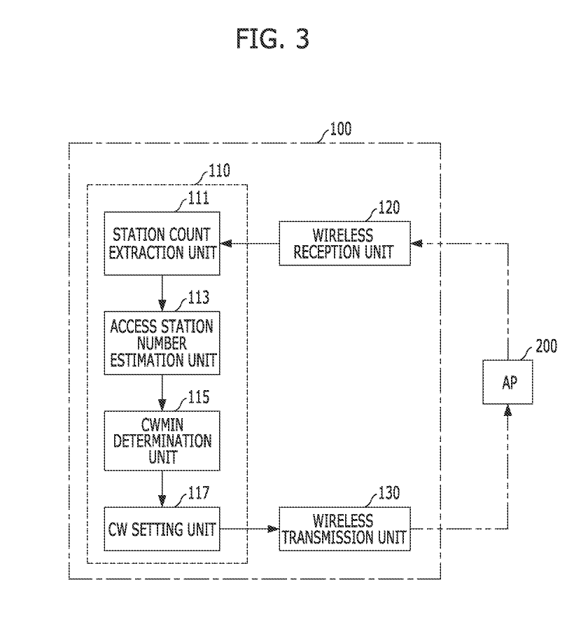

FIG. 3 is a block configuration diagram of a media access control apparatus in a wireless LAN system in accordance with an embodiment of the present invention. The media access control apparatus 110 in accordance with the embodiment of the present invention includes a station count extraction unit 111, an access station number estimation unit 113, a CWmin determination unit 115 and a CW setting unit 117.

The station count extraction unit 111 extracts a value of a station count field, i.e., a station count, contained in a BSS load element in information contained in a beacon received by a station 100 from an access point 200 through a wireless reception unit 120.

The access station number estimation unit 113 estimates a number of stations 100 accessing the access point 200, when the BSS load element does not exist in the beacon received by the station 100 from the access point 200 through the wireless reception unit 120, and therefore, the station count extraction unit 111 cannot extract the station count.

The CWmin determination unit 115 determines a CWmin based on the number of stations 100 accessing the access point 200, which the station count extraction unit 111 extracts or the access station number estimation unit 113 estimates. The CW setting unit 117 sets a CW based on the CWmin determined by the CWmin determination unit 115.

The station 100 transmits data to the access point 200 through a wireless transmission unit 130 based on the CW set by the CW setting unit 117.

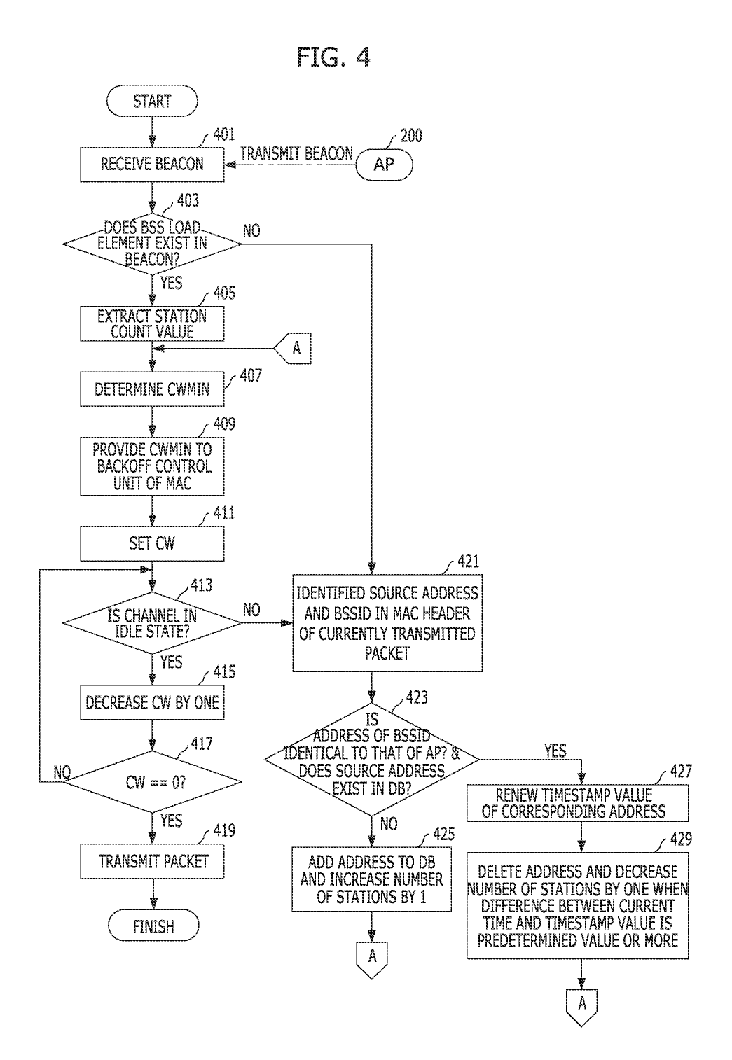

FIG. 4 is a control flowchart illustrating a media access control method in the wireless LAN system in accordance with the embodiment of the present invention. As illustrated in FIG. 4, in the media access control apparatus 110 in accordance with the embodiment of the present invention, if the station receives a beacon from the access point 200 through the wireless reception unit 120 (step 401), the station count extraction unit 111 extracts a station count value in a BSS load element existing in the beacon (steps 403 and 405). The station count value extracted in the BSS load element is a number of stations 100 accessing the access point 200, and the number of stations 100 is used to determine a CWmin at step 407.

At the step 407, the CWmin determination unit 115 determines the CWmin based on the number of stations 100, which the station count extraction unit 111 extracts. When assuming that the number of stations 100 is N, the CWmin is in proportion to the N. Since an exact constant is changed depending on a system, a proportional constant is obtained through an experiment, and the exact constant is evaluated using a calculating formula.

At step 409, the CWmin determination unit 115 provides the CWmin determined at the step 407 to a backoff control unit of an MAC so that the backoff control unit of the MAC executes a backoff algorithm. Accordingly, at step 411, the CW setting unit 117 sets a CW based on the CWmin determined by the CWmin determination unit 115. When data to be transmitted by the station 100 is generated, the CW setting unit 117 sets the CW by randomly selecting a value in the range from 0 to the CWmin calculated above.

Subsequently, at step 413, the CW setting unit 117 identifies whether or not a channel is in an idle state during one slot time. If the channel is in the idle state, the CW setting unit 117 decreases a CW value by one at step 415. If the CW value becomes 0 at step 417, the station transmits data to the access point 200 through the wireless transmission unit 130 at step 419. In this case, the CWmin determination unit 115 maintains the CWmin as it is, even though the station 100 does not receive an ACK due to a channel error or collision between packets.

Meanwhile, when the BSS load element does not exist in the beacon at the step 403, the station count value cannot be extracted at the step 405, and therefore, the number of stations 100 cannot be identified. Accordingly, the number of stations 100 accessing the access point 200 is estimated, and the CWmin is calculated based on the estimated number of stations 100. To this end, the access station number estimation unit 113 estimates the number of stations 100 accessing the access point 200 using the following method.

At the step 413, it is identified whether or not the channel is in the idle state. If the channel is in the idle state, the CW setting unit 117 decreases the CW by one at the step 415. However, if the channel is not in the idle state, the access station number estimation unit 113 identifies a source address field and a BSSID field in an MAC header field of a currently transmitted packet at step 421. The step 421 is performed by the access station number estimation unit 113 even when the BSS load element does not exist in the beacon at the step 403.

As a result identified at the step 421, if it is decided that the BSSID field is identical to an address of the access point 200 to which the BSSID field currently belongs and an address in the source address field does not exist in a DB at step 423, the access station number estimation unit 113 estimates the number of stations 100 by increasing the number of stations 100 by one while adding the address to the DB at step 425. Subsequently, at the step 407, the CWmin determination unit 115 determines the CWmin based on the number of stations 100, estimated at the step 425.

Meanwhile, if the BSSID field is identical to the address of the access point 200 to which the BSSID field currently belongs and the address in the source address field exists in the DB at the step 423, the access station number estimation unit 113 renews a timestamp value of the corresponding address at step 427. At step 429, the access station number estimation unit 113 periodically identifies the timestamp value existing in the DB. If the difference between a current time and the timestamp value becomes a predetermined value or more, the access station number estimation unit 113 estimates the number of stations 100 by deleting the address from the DB and decreasing the number of stations 100 by one. Subsequently, at the step 407, the CWmin determination unit 115 determines the CWmin based on the number of stations 100, estimated at the step 429.

As such, in the media access control apparatus 110 in accordance with the embodiment of the present invention, when the number of stations 100 cannot be identified through the beacon, the access station number estimation unit 113 estimates the number of stations 100 using the aforementioned method so that the CWmin determination unit 115 can determine the CWmin.

As described above, in the media access control apparatus and method in the wires LAN system in accordance with the present invention, a station determines a CW value based on information on other stations accessing a same access point and information on the idle state of a channel. Thus, an inefficient CW value cannot be set in the DCF, so that it is possible to improve the performance and efficiency of the entire wireless LAN system.

While the present invention has been described with respect to the specific embodiments, it will be apparent to those skilled in the art that various changes and modifications may be made without departing from the spirit and scope of the invention as defined in the following claims.

What is claimed is:

1. A media access control apparatus in a wireless local area network (LAN) system, the apparatus comprising:
a station count extraction unit configured to extract a station count contained in a BSS load element in information existing in a beacon received by a station from an access point through a wireless reception unit;
an access station number estimation unit configured to estimate a number of stations accessing the access point when the BSS load element does not exist in the beacon received by the station from the access point through the wireless reception unit;
a minimum contention window (CWmin) determination unit configured to determine a CWmin based on the number of stations accessing the access point, which the station count extraction unit extracts or the access station number estimation unit estimates; and
a contention window (CW) setting unit configured to set a CW based on the CWmin determined by the CWmin determination unit and provide the set CW to a wireless transmission unit so as to transmit data to the access point.

2. The apparatus of claim 1, wherein the access station number estimation unit estimates the number of stations accessing the access point and calculates the CWmin based on the estimated number of stations, when the BSS load element does not exist in the beacon.

3. A media access control method in a wireless LAN system, the method comprising:
extracting a station count from a BSS load element existing in a beacon, when a station receives the beacon from an access point through a wireless reception unit;
determining a CWmin based on the extracted station count;
setting a CW by randomly selecting a value in a range from 0 to the determined CWmin; and
transmitting a packet to the access point through a wireless transmission unit, when the CW becomes 0 by decreasing the CW by one when a channel is in an idle state during one slot time.

4. The method of claim 3, wherein, after said transmitting of the packet to the access point, although the station does not receive an acknowledgement (ACK) due to a channel error or collision between packets, the CWmin is maintained as it is.

5. The method of claim 3, wherein, when the BSS load element does not exist in the beacon, a number of stations accessing the access point is estimated, and the CWmin is calculated based on the estimated number of stations.

6. The method of claim 5, wherein said estimating of the number of stations identifies a source address field and a BSSID field in an MAC header field of a currently transmitted packet when the channel is not in the idle state, adds an address to a database (DB) when the BSSID field is identical to the address of the access point to which the BSSID field belongs and the address existing in the source address field does not exist in the DB, and estimates a number obtained by increasing a current number of stations by one as the number of stations accessing the access point.

7. The method of claim 5, wherein said estimating of the number of stations identifies a source address field and a BSSID field in an MAC header field of a currently transmitted packet when the channel is not in the idle state, renews a timestamp value of an address when the BSSID field is identical to the address of the access point to which the BSSID field belongs and the corresponding address existing in the source address field does not exist in a DB, deletes the address from the DB when the difference between a current time and the timestamp value is a predetermined value or more by periodically identifying the timestamp value existing in the DB, and estimates a number obtained by increasing a current number of stations by one as the number of stations accessing the access point.

8. The method of claim 3, wherein, in said determining of the CWmin based on the extracted station count, the CWmin is determined by multiplying the station count by a proportional constant of a corresponding system.
